(19) United States
(12) Patent Application Publication
(10) Pub. No.: US 2010/0084423 A1
(43) Pub. Date: Apr. 8, 2010

(54) Dental flosser dispenser apparatus

(76) Inventor: Joshua Zeitman, Brooklyn, NY (US)

Correspondence Address: BERNARD MALINA, ESQ.;MALINA & ASSOCIATES, PLLC, Suite 501, 60 East 42nd Street, New York, NY, 10165, US

(21) Appl. No.: 12/285,440

(22) Filed: Oct. 2, 2008

(51) Int. Cl. B65H 3/32; B65G 59/00; B65H 3/00

(52) U.S. Cl. 221/267; 221/286; 221/208

(57) ABSTRACT

A dispenser includes a base and a storage sleeve which contains a quantity of dental flossers. The dental flossers are maintained without any mutual entanglement. The base includes a dispenser slot, an operating arm and an operating button. Pressing the operating button causes the operating arm to engage a single dental flosser and push the single dental flosser through the dispensing slot.

### FIELD OF THE INVENTION

The present invention relates generally to the field of equipment for oral hygiene and more particularly, to a dental flosser dispenser apparatus.

### BACKGROUND OF THE INVENTION

The importance of regular flossing has been well established as a significant element in the maintenance of a proper oral hygiene program. Various types of dental flosser equipment has been developed as an addition to the simple spool of dental floss which is typically wound onto the user's fingers to maintain proper tension during the flossing action.

The prior art includes disposable dental flossers which are formed as a small frame which includes a pair of arms and a handle. A length of dental floss extends between the outer ends of the arms and the handle is used to manipulate the frame during the dental flossing procedure. The prior art dental flossers are typically packaged in bulk either in a small plastic bag containing a quantity of dental flossers or in a small plastic box which forms a part of a blister package for retail sale.

The prior art packaging of dental flossers results in several disadvantages. The dental flossers tend to become tangled within the package resulting in difficulty in withdrawing a dental flosser one at a time for use. In addition, the insertion of the user's hands into the package to withdraw a dental flosser for use tends to contaminate the balance of the dental flossers in the package. This disadvantage is especially clear when more than one person uses the package of dental flossers.

### OBJECTS AND SUMMARY OF THE INVENTION

It is an object of the present invention to provide a dental flosser dispenser apparatus which enables a user to withdraw a single dental flosser in a convenient manner.

Another object of the present invention is to provide a dental flosser dispenser apparatus which enables a user to withdraw a dental flosser without touching the remaining dental flossers in a package.

Another object of the present invention is to provide a dental flosser dispenser apparatus which maintains a store of dental flossers in a clean condition.

Another object of the present invention is to provide a dental flosser dispenser apparatus which maintains a store of dental flossers free of mutual entanglement.

Another object of the present invention is to provide a dental flosser dispenser apparatus in which dental flossers are packaged in a convenient manner for retail sale.

Yet another object of the present invention is to provide a dental flosser dispenser apparatus which is composed of a relatively small number of component parts which can be manufactured efficiently in volume resulting in a relatively low unit cost.

Other objects and advantages of the present invention will be apparent hereinafter.

In accordance with the present invention, there is provided a dental flosser dispenser apparatus which includes a dental flosser storage sleeve and a dispenser base. The storage sleeve contains a quantity of dental flossers in a vertical array in which the dental flossers are maintained without any mutual entanglement. The storage sleeve is removably mounted in a vertical orientation on a dispenser base.

The dispenser base includes a dispenser slot, an operating arm, and an operating button. Pressing the operating button causes the operating arm to engage a dental flosser and push the dental flosser through the dispenser slot for use.

The operating button is part of a mechanism which is spring loaded and releasing the button causes the operating arm to return to its original position. The next flosser in the storage sleeve drops into position under the influence of gravity ready to be dispensed.

### BRIEF DESCRIPTION OF THE DRAWINGS

Other important objects and advantages of the invention will be apparent from the following detailed description of the invention taken in connection with the accompanying drawings in which:

FIG. 1 is an overall perspective view of a dental flosser dispenser apparatus made according to the present invention;

FIG. 2 is a cross-sectional view taken along the line 2-2 of FIG. 1 showing the dental flossers stored within the storage sleeve;

FIG. 3 is a top plan view of the dispenser base with the storage sleeve shown removed;

FIG. 4 is an overall perspective view of the dispenser base with the cover shown removed and showing the dispenser mechanism;

FIG. 5 is an overall perspective view similar to FIG. 4 showing the operating button depressed and the operating arm rotated into the dispensing position;

FIG. 6 is a schematic view of the operating mechanism taken along the line 6-6 of FIG. 4;

FIG. 7 is a top plan view of the actuating link shown removed from the operating mechanism;

FIG. 8 is a front elevation view of the storage sleeve shown with portions broken away for clarity of illustration;

FIG. 9 is a fragmentary elevation view taken along the line 9-9 of FIG. 3;

FIG. 10 is a fragmentary elevation view taken along the line 10-10 of FIG. 3;

FIG. 11 is a fragmentary schematic view taken along the line 11-11 of FIG. 6;

FIG. 12 is a fragmentary schematic view showing the dispensing of a dental flosser; and

FIG. 13 is a fragmentary elevation view, partially in section, taken along the line 13-13 of FIG. 7 drawn to an enlarged scale.

### DETAILED DESCRIPTION OF THE INVENTION

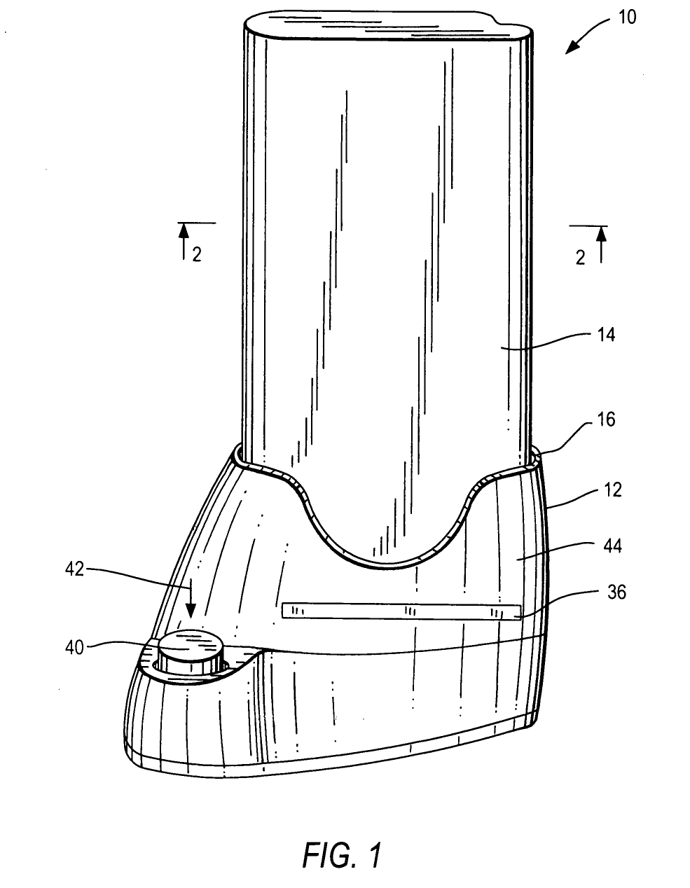

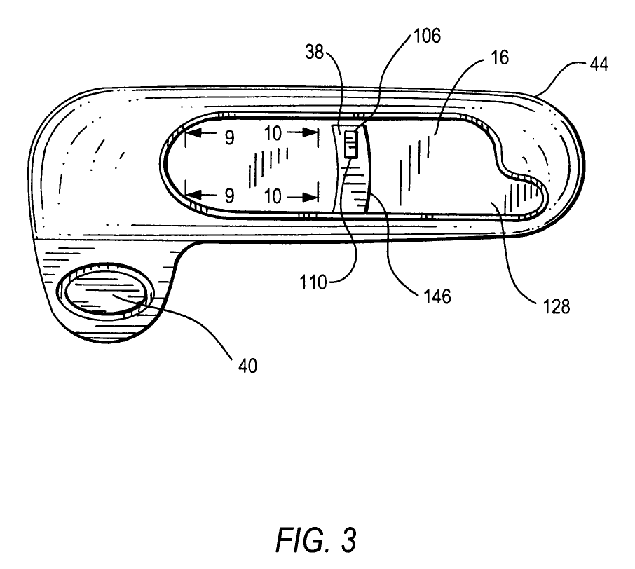

With reference to the drawings, there is shown in FIGS. 1-13 a dental flosser dispenser 10 which includes a dispenser base 12 and a storage sleeve 14 which fits into a cavity 16 formed in the dispenser base 12.

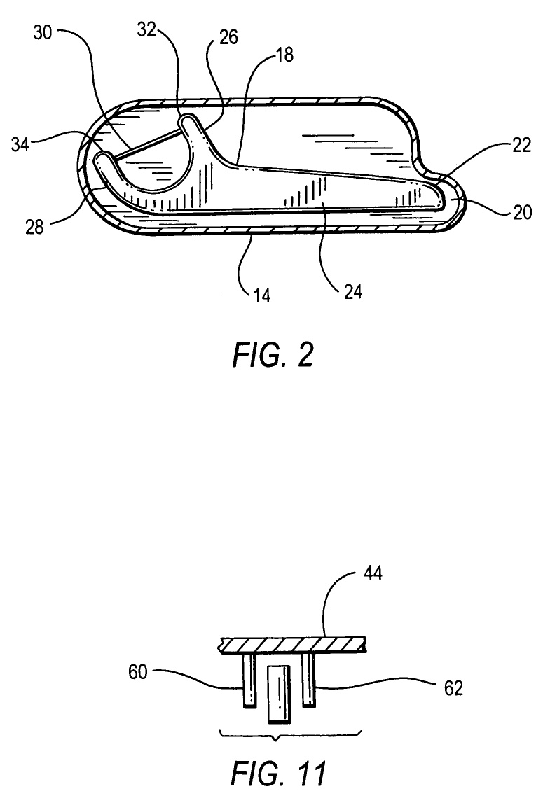

The storage sleeve 14 contains a quantity of dental flossers 18 in a vertical stack or vertical array as is shown in FIG. 2. The contour of the sleeve 14 which generally fits the flossers 18 and especially including the cavity portion 20, which accepts the handle 22 portion of the flossers 18, maintains the flossers 18 without any mutual entanglement between the flossers 18. The flossers 18 are conventional in nature and include a frame portion 24 with a pair of arms 26, 28. Dental floss 30 is secured to the outer ends 32, 34 of the arms 26, 28.

The dispenser base 12 includes a dispenser slot 36, an operating arm 38, and an operating button 40. Pressing the operating button 40 in the downward direction shown by the arrow 42 in FIG. 1 causes the operating arm 38 to engage and dispense a single flosser 18 through the dispenser slot 36.

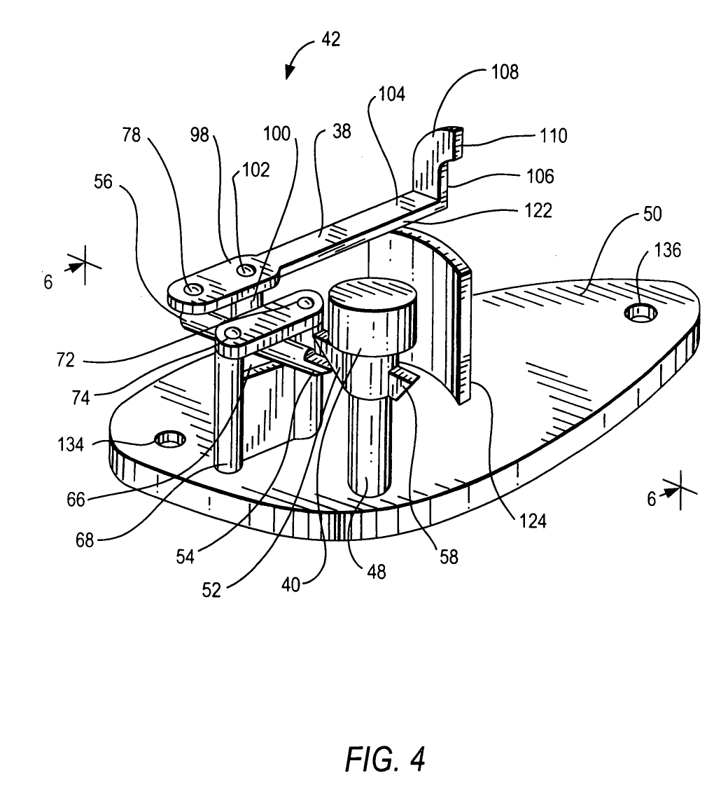

The operating button 40 is part of a spring loaded mechanism 42 which is best shown in FIGS. 4, 5 and 6.

In FIGS. 4, 5 and 6, the base cover 44 has been removed for clarity of illustration.

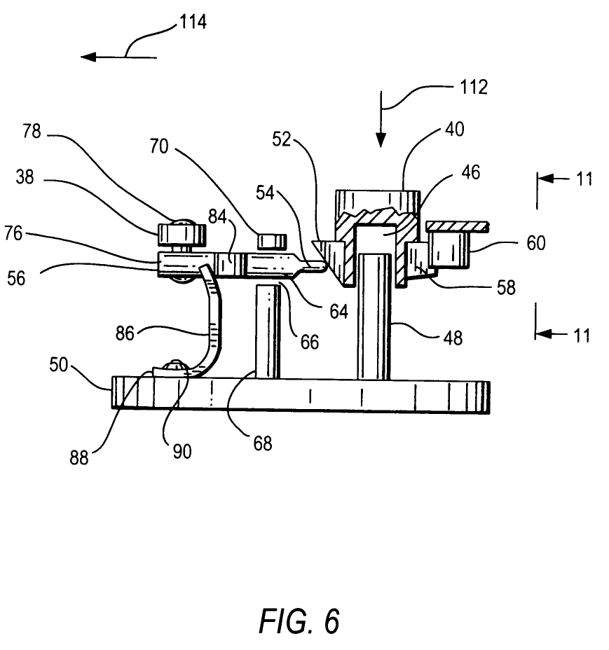

The operating button 40 has a cavity 46 which rides on a vertical post 48 which projects from the base plate 50. The operating button 40 includes an inclined portion 52 which is in contact with the first end 54 of the actuating link 56. The operating button 40 also includes a projecting fin 58 which rides between a pair of guide walls 60, 62, which are formed in the base cover 44. The guide walls 60, 62 prevent rotation of the operating button 40 and thereby maintain the inclined portion 52 of the operating button 40 in contact with the actuating link 56 as shown in FIGS. 6 and 11.

As is shown in FIGS. 4, 5 and 6, an intermediate portion 64 of the actuating link 56 rides in a slot 66 which is formed by a wall 68 which projects from the base plate 50 and the guide cover 70, which is connected to the wall 68 by fasteners 72, 74.

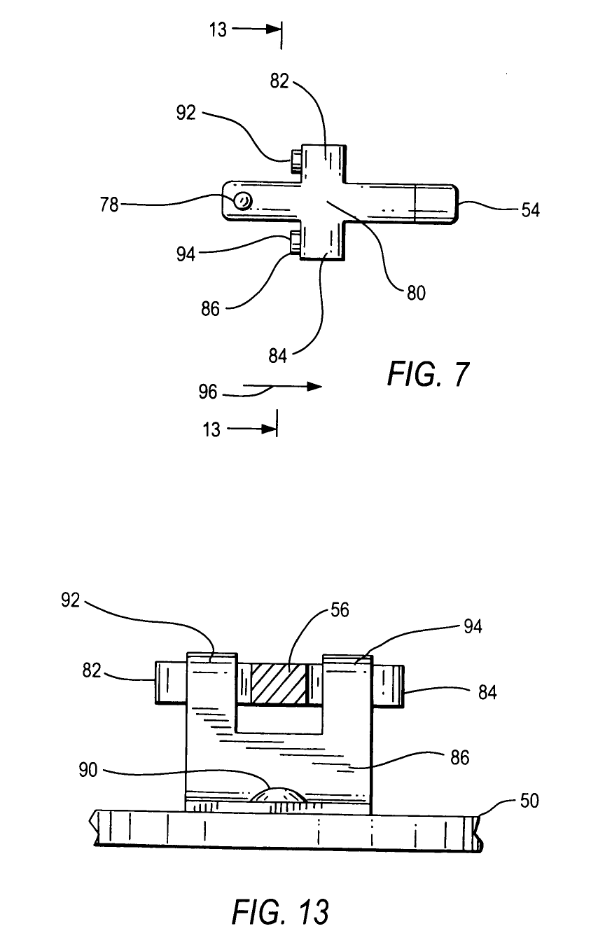

The second end 76 of the actuating link 56 is connected to the operating arm 38 via a pivot 78. An intermediate portion 80 of the actuating link 56 includes the integrally formed cross portions 82, 84. A bifurcated leaf spring 86 has an end 88 connected to the base plate 50 by a fastener 90 and a pair of upwardly directed end portions 92, 94, which bear upon the cross portions 82, 84 as shown in FIG. 7. The leaf spring 86 biases the actuating link 56 in the direction shown by the arrow 96 in FIG. 7 and thus maintains contact between the first end 54 of the actuating link 56 and the inclined portion 52 of the operating button 40.

The bifurcated leaf spring 86 maintains balanced forces on the cross portions 82, 84 during the operation of the dental flosser dispenser 10 and ensures proper orientation of the actuating link 56.

The operating arm 38 has an intermediate portion 98 which is connected to a post 100 via a pivot 102. The post 100 projects upwardly from the base plate 50. The end 104 of the operating arm 38 includes a vertical portion 106 which includes a curved back 108 portion and a vertical catch surface 110.

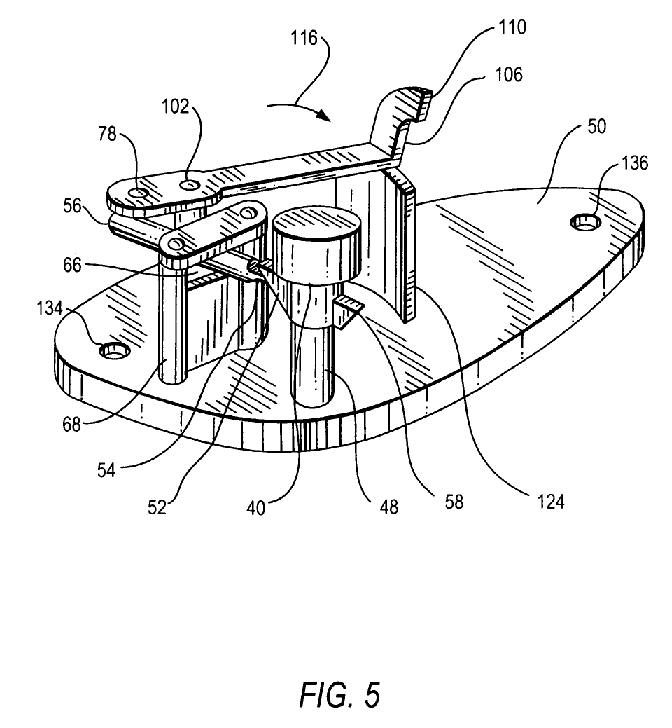

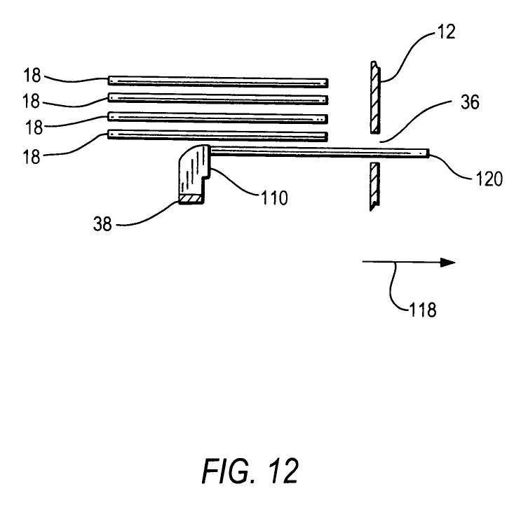

When the operating button 40 is pressed in the downward direction shown by the arrow 112 in FIG. 6, the inclined portion 52 forces the actuating link 56 to move in the direction shown by the arrow 114 in FIG. 6. This motion of the actuating link 56 causes rotation of the operating arm 38 from the position shown in FIG. 4 to the position shown in FIG. 5 as illustrated by the arrow in FIG. 5. The rotation of the operating arm 38 causes the vertical catch surface 110 of the operating arm 38 to catch a single dental flosser 120 which is in the storage sleeve 14 and force the dental flosser 120 to move out of the base 12 in the direction shown by the arrow 118 in FIG. 12. The dental flosser 120 passes through the dispensing slot 36 and can be conveniently grasped by a user. This action is illustrated schematically in FIG. 12.

When the operating button 40 is released, the leaf spring 86 forces the actuating link 56, the operating button 40 and the operating arm 38 to return to the original position shown in FIG. 4. The stack of dental flossers 18 drops to occupy the space made vacant by the dental flosser 120 which has been dispensed and the operating arm swings 38 behind the stack of flossers 18 so that the catch surface 110 is ready to engage and dispense another dental flosser 18 when the operating button 40 is pressed again.

An intermediate portion 122 of the operating arm 38 rides between an upwardly projecting wall 124 portion which projects from the base plate 50 and a downwardly projecting wall portion 126 which projects from a wall 128 which is part of the cavity 16 and the base cover 44 as is shown in FIG. 10.

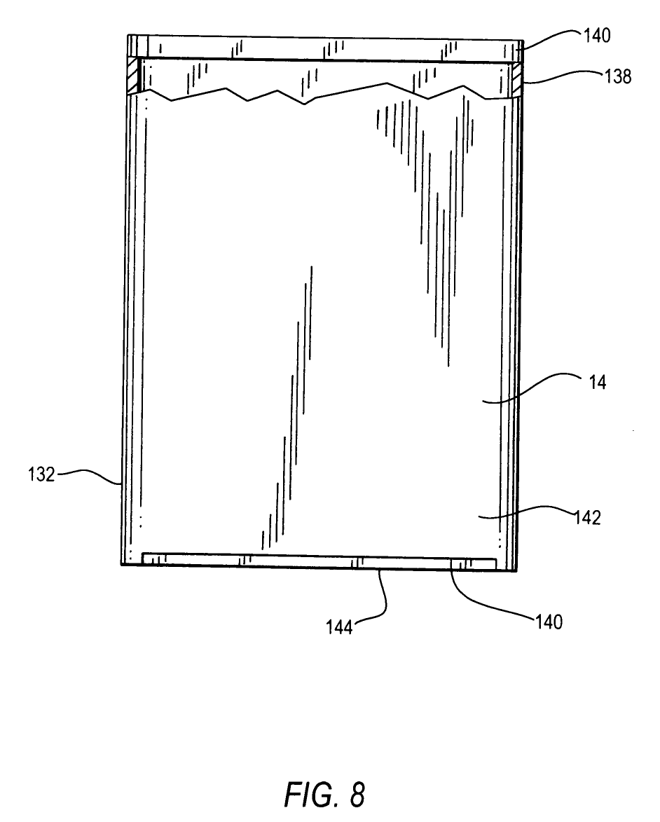

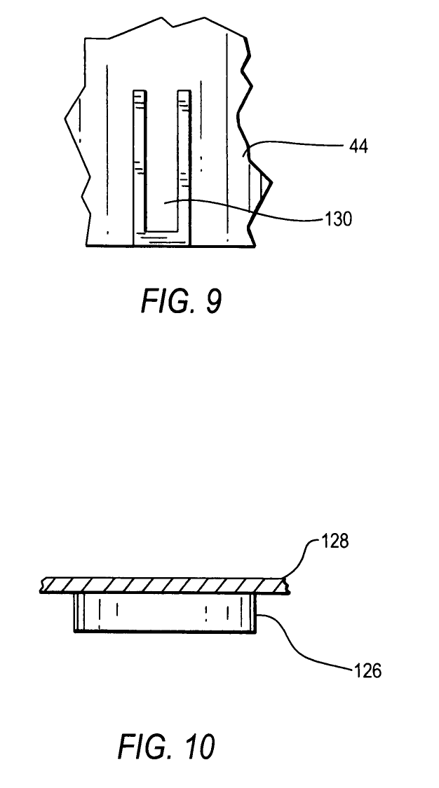

The base cover 44 includes a pair of identical integrally formed locating tabs 130, one of which is shown in FIG. 9. The locating tabs 130 ensure proper retention of the end 132 of the storage sleeve 14 within the cavity 16 formed in the base cover 44. The base cover 44 and the base plate 50 are connected by conventional fasteners (not illustrated) which pass through holes 134, 136 in the base plate 50.

As is shown in FIG. 8, the upper 138 storage sleeve 14 includes a cap 140 which facilitates refilling the storage sleeve 14 with a new supply of dental flossers 18 and an opening 140 in the wall 142 near the open bottom 144 which facilitates the dispensing of the dental flossers 18.

The open bottom 144 of the sleeve 14 rests on the wall 128 of the cavity 16 and the end 106 of the operating arm 38 rides in the slot 146 of the bottom cover 44.

The foregoing specific embodiment of the present invention as set forth in the specification herein is for illustrative purposes only. Various deviations and modifications may be made within the spirit and scope of this invention, without departing from the main theme thereof.

What is claimed is:

1. A dental flosser dispenser apparatus comprising:
a base;
a storage sleeve with said storage sleeve removably mounted on said base, with said storage sleeve containing a plurality of dental flossers;
a dispenser mechanism mounted in said base with said dispenser mechanism comprising;
an operating button and an operating arm for dispensing one of said plurality of said dental flossers at a time responsive to operation of said operating button.

2. The dental flosser dispenser apparatus as claimed in claim 1 wherein said operating mechanism further comprises an inclined portion formed on said operating button.

3. The dental flosser dispenser apparatus as claimed in claim 1 wherein said operating mechanism further comprises an actuating link, and a biasing spring disposed bearing on said actuating link and urging said actuating link into contact with said operating button.

4. The dental flosser dispenser apparatus as claimed in claim 1 wherein said operating mechanism further comprises a base plate and a pivotal connection disposed connecting said base plate and said operating arm.

5. The dental flosser dispenser apparatus as claimed in claim 1 wherein said storage sleeve has an open bottom portion.

6. The dental flosser dispenser apparatus as claimed in claim 1 wherein said base further comprises a dispensing slot portion.

7. The dental flosser dispenser apparatus as claimed in claim 1 wherein said operating arm further comprises a catch portion.

8. The dental flosser dispenser apparatus as claimed in claim 1 further comprising guide portions disposed in said base for guiding motion of said operating arm.

9. The dental flosser dispenser apparatus as claimed in claim 1 wherein said base further comprises an operating arm slot portion and wherein said operating arm further comprises an intermediate portion disposed projecting through said operating arm slot portion.

10. The dental flosser dispenser apparatus as claimed in claim 1 wherein said base further comprises a cavity portion with said cavity portion proportioned to removably accept said storage sleeve.

11. The dental flosser dispenser apparatus as claimed in claim 3 further comprising a pivotal connection disposed connecting said operating arm and said actuating link.

12. The dental flosser dispenser apparatus as claimed in claim 3 wherein said biasing spring comprises a bifurcated leaf spring.
